(19) United States
(12) Patent Application Publication
(10) Pub. No.: US 2021/0376546 A1
(43) Pub. Date: Dec. 2, 2021

(54) COMPACT TRAVEL PLUG ADAPTER WHICH CAN BE GROUNDED

(71) Applicant: TRAVEL BLUE LTD., Edgeware Middx (GB)

(72) Inventors: ALASDAIR MAX PAUL BARNETT, CAMBRIDGE CAMBRIDGESHIRE (GB); RICHARD ALBERT NORMAN, ELY CAMBRIDGESHIRE (GB); BRUCE STANLEY JOHN HUTCHISON, COTTENHAM CAMBRIDGESHIRE (GB)

(73) Assignee: TRAVEL BLUE LTD., EDGWARE, MIDDLESEX (GB)

(21) Appl. No.: 16/346,846

(22) PCT Filed: Nov. 1, 2017
(86) PCT No.: PCT/EP2017/077969

§ 371 Date: May 1, 2019

(30) Foreign Application Priority Data
Nov. 1, 2016 (EP) 16196762.5

(51) Int. Cl. H01R 27/00; H01R 31/06

(52) U.S. Cl. CPC H01R 27/00; H01R 31/06

(57) ABSTRACT

The present invention relates to a travel plug adapter, which will also be referred to herein as a travel adapter, for short. Using such an adapter it is possible to insert power plugs of a certain (domestic) standard into the outlets present at the travel destination. The travel plug adapter (10) is particularly one which has a housing, a plug receptacle (16) and at least a first plug (34) of a first standard and a second plug (36) of a second standard, wherein each plug is assigned an actuation slider (22, 24, 26), which is guided outwardly through a slide slot (42) in the housing and is designed to displace the plug between a standby position, in which the plug is disposed substantially inside the housing, and a usage position, in which the plug is usably disposed outside the housing, wherein the first plug comprises a plug body and a first contact pin and a second contact pin, wherein, in the usage position, both the plug body and the first contact pin and the second contact pin are usably disposed outside the housing, and, in the standby position, both the plug body and the first contact pin and the second contact pin are disposed in the housing, wherein the second plug comprises a third contact pin and a fourth contact pin, and the third contact pin and the fourth contact pin are also guided in the plug body of the first plug.

### FIELD OF THE INVENTION

The present invention relates to a travel plug adapter, which will also be referred to herein as a travel adapter, for short. Using such an adapter it is possible to insert power plugs of a certain (domestic) standard into the outlets present at the travel destination. To this end, the travel plug adapter needs a plug receptacle of a first standard and a power plug of another standard. In this case, the issue more precisely is a travel plug adapter that can be inserted into outlets of at least a first standard and a second standard. To this end, power plugs of a first standard and a second standard may be used alternatively in the travel plug adapter.

### BACKGROUND OF THE INVENTION

Travel plug adapters or travel adapters of this type are being used more and more in times of increasing global travel and commerce. There is therefore a need for compact, easily transportable travel plug adapters that are suitable for outlets of a number of different standards.

Chinese patent application CN 101872911 A discloses a travel plug adapter having an essentially round housing. Power plugs are housed in the interior of the housing and may be moved out of the housing. In this manner at least three different types of power plugs may be used. The desired power plug is selected in that the upper housing part is rotated relative to the lower housing part. The upper housing part has an individual actuation slider that projects outward. This actuation slider may be caused to engage with various power plug elements. The power plug elements are arranged adjacently to one another. To this end the slider is rotated into a position above the power plug that is to be moved out of the housing from below.

This travel adapter may be useful for many purposes. However, a round housing shape is specified by the mechanics. The round housing must also surround the various adjacently arranged power plug elements, such that the housing is not very compact on the whole.

German patent DE 10 2011 014 920 B4 discloses another travel adapter, which is called a universal plug adapter. In this travel adapter, a plurality of sets of pins are provided in an exterior housing. Each set of pins is connected to a control element with which it may be moved from outside. The control elements are guided in the housing by slide slots. The control elements are also guided using a blocking plate provided inside the exterior housing. This blocking plate has a guide track, and the control elements can move through the recesses thereof. The guide track provides an upper end position and a lower end position. The blocking plate is resiliently pre-stressed so that a control element may be securely retained in the upper end position or in the lower end position. The control element, and thus the corresponding set of pins, may be released from the end positions and moved upward or downward in that a selector lever also provided outside in addition to the control elements is actuated. Pressing this selector lever moves the blocking plate against the spring force. In this way the pins may be moved out of their upper or lower end position using the control elements.

In this solution, the outer control elements are used both for moving the sets of pins out of a first end position, a standby position, into a second end position, a usage position, and for locking the sets of pins in these positions. It is a drawback that the selection lever must also be operated during the movement of the sets of pins using the control elements. This prevents comfortable one-hand operation. The control elements also take up a lot of space on the plug surface. This prevents a free design-oriented configuration and attaining a compact structural form. The housing is designed such that its upper end has the form of a Schuko plug. This again leads to a housing form that is not very compact. The housing again also cannot be freely designed in order to achieve an attractive shaping. Provision is also made so that contacts for plugs of quite a different standard are slid out from the above-mentioned cylindrical main body in the manner of a Schuko plug. This results in an unfamiliar plug configuration which is irritating for the user.

The object of the present invention is to make available an improved travel plug adapter that avoids the drawbacks of the prior art. The travel adapter should be able to be produced cost-effectively and reliably, should be easy to transport and operate, and should be very safe electrically.

The inventive travel plug adapter has a housing that may have various shapes. For instance, as a rule a block shape is practical for transport. However, the mechanics of the travel plug adapter are designed such that the housing shape may largely be freely selected. It is advantageous when the housing has at least one flat side, but the mechanics may also be adapted to curved housing surfaces. The housing may be embodied in one piece or in a plurality of pieces. It has proved useful to embody the housing in two parts, specifically with a lower housing part and an upper housing part. These may be detachably connected to one another, for instance using mechanical means, usefully using a screw connection.

The housing should have at least one plug receptacle. The latter is usefully provided on the housing upper side. The plug receptacle may have different shapes, depending on the type of power plug (hereinafter “plug” for short) to be received. For instance, if a Schuko plug is to be received, the plug receptacle will have an essentially cylindrical depression and in addition female connectors for receiving the contact pins of the Schuko plug. For other types of plugs, no depression or groove is necessary. It may be useful to provide a flat upper housing side in which a plurality of female contacts are provided. As a rule, at least two female connectors should be provided that form a female connector pair for receiving a plug of a standard. It may be useful to provide a plurality of female connector pairs in order to be able to receive a plurality of plugs of different standards. If the plugs also have grounding conductors and the plug receptacle is intended to provide the opportunity of grounding, as a rule it is also necessary to provide a third female connector or a third contact per plug to be received.

The travel plug adapter should furthermore have at least one plug of a first standard and a second plug of a second standard. (Such plugs are sometimes also called plug-in pin sets). The plug of the first standard may be, for instance, an EU plug or Schuko plug, and the plug of the second standard may be a US plug. The plugs may have two pins, that is, they may not be grounded, or they may have three pins, so that a grounding pin may be provided. The present travel plug adapter is thus suitable for use in more than one country. Usefully, and as a rule, it is also necessary for the first plug and the second plug to be used alternatively.

Plugs of many standards have a plug body, which protrudes into the outlet and of which the shape is determined by the shape of the outlet. By way of example, Schuko plugs have a plug body of this type. This plug body has a cylindrical basic shape with two protruding grooves and two indentations. The grooves define the orientation of the plug body necessary in accordance with the standard. Grounding contacts can be provided in the indentations. In the case of a Schuko plug, two contact pins protrude downwardly from the plug body, and with use of the plug these are the current-conducting contacts, i.e. the positive and negative poles. An EU plug also has a plug body which is inserted into an outlet and of which the shape is determined at least in part by the shape of the outlet. Plugs for Switzerland and for Italy have a plug body in a similar manner. The plug bodies of a Swiss plug and of an Italian plug resemble one another. Both have three contact pins at the front. The outer contact pins form the positive and the negative pole. The middle contact pin is used for grounding. In the case of an Italian plug, the middle contact pin is arranged centrally between the contact pins for the positive and negative poles. In the case of a Swiss plug, the middle contact pin is offset from the line of these two contact pins.

Within the scope of the present invention, the word ‘plug body’ describes the part of a plug which is inserted into the outlet and of which the shape is determined at least substantially by the standard of the outlet. A further part of the plug housing is generally arranged above the plug body and is referred to herein as the main plug housing. The main plug housing serves for cable routing; grip recesses or the like are often also provided. In contrast to the plug body, the main plug housing is not defined by the shape of the outlet.

Plugs of other standards do not require a plug body. The corresponding outlets have a substantially flat top side, which only has connectors for receiving contact pins. These connectors are generally circular or slot-like. Plugs which have no plug body and which have only contact pins protruding from a plug housing are suitable for the corresponding outlets.

The travel plug adapter may also comprise three or more plugs. Travel plug adapters with three or four plugs have proved to be very useful. At least one of the plugs, but as a rule all of the plugs, may be moved from a standby position, in which the plug is essentially disposed in the housing, to a usage position. In the usage position, the plug is usably disposed entirely or at least in part outside of the housing. Often it is possible for the plug to be moved completely back into the housing when it is returned to the standby position. It is useful that the plug may be moved far enough back into the housing that it is not in the way of other plugs.

A travel plug adapter according to the present invention will have a first plug, which comprises a plug body and a first and a second contact pin. By way of example, this first plug could thus be a Schuko plug having a plug body of the known cylindrical shape and two contact pins, which serve as positive and negative poles. In the usage position, both the plug body and the first and the second contact pin are arranged usably outside the housing. Here, the plug body protrudes from the housing and the first and second contact pins in turn protrude from the plug body. In the standby position the two contact pins are retracted into the plug body, and the plug body itself is retracted into the housing. The first plug can of course also be a plug of another standard.

The travel plug adapter according to the present invention will also have a second plug of another standard, which in turn has a third contact pin and a fourth contact pin. In accordance with the invention, the third and the fourth contact pins are also guided in the plug body of the first plug. The second plug can thus be transferred into the usage position in that the third contact pin and the fourth contact pin protrude from the plug body of the first plug. These can then be inserted without this plug body into an outlet of a matching standard. The provision of the third and fourth contact pin in the plug body of the first plug also has the advantage that the electrical feed lines to these contact pins do not run far from those for the first and second contact pins. Short lines can therefore be used. In addition, the lines cannot be pinched by the displacement of the plug body, since they can be guided in the interior of said plug body.

Alternatively, it would also be conceivable for the second plug to be used together with the plug body of the first plug. A second plug having the same plug body, but a different contact pin arrangement compared to the first plug would then be provided. This would be conceivable by way of example in order to insert a first plug corresponding to the Swiss standard and a second plug corresponding to the Italian standard, for example.

In the sense of the invention it is advantageous when the second plug is designed such that merely the third and the fourth contact pin have to be transferred into the usage position so that the second plug is in the usage position.

It is useful to provide a travel plug adapter in which the first plug also has a grounding contact which is disposed outside the plug body. A grounding contact of this type can bear against the plug housing externally for example. In the case of a plug of this type there is enough space inside the plug body to provide numerous contacts. In addition, the likelihood of accidental malcontact of a current-conducting contact with the grounding contact is lower.

It is also expedient when the second plug has a grounding contact arranged at a distance from the plug body of the first plug. A grounding contact of this type therefore does not bear externally on the plug body, but instead is provided at a distance of typically a few millimetres (2 to 10 mm). By way of example, the grounding contact can be provided in the form of a third contact pin, which is arranged parallel to contact pins for positive and negative poles.

The travel plug adapter can have more than the first and the second plug, and travel plug adapters having three or four plugs are often useful. By way of example, a third plug can be provided, in which at least one contact is guided in the plug body of the first plug. It is conceivable, for example, that the grounding contact of the third plug is guided in the plug body of the first plug. It would also be conceivable that two current-conducting contacts of the third plug (positive and negative poles) are guided in the plug body of the first plug.

It is also expedient when the travel plug adapter is constructed such that the second plug and the third plug have the same polarisation. Identical poles are then present on each side of the central plane of the plug, for example positive pole on the left and negative pole on the right. The central plane divides the plug centrally between the current-conducting poles, at least the current-conducting poles of the second and third plug. This allows a simple and safe wiring of the plug. In principle it is easily possible to use the travel plug adapters in positions rotated 180° relative to one another. However, it is often advantageous to limit this use mechanically such that the travel plug adapter can be used only in one fixed position and the polarisation can then be selected favourably on the basis of this position.

It is also particularly useful when the travel plug adapter is mechanically designed such that the plug body of the first plug has guide slots. Here, a guide slot can be provided for a supporting element of the second plug. By way of example, a supporting element of this type can be a supporting bar which guides the third contact pin and the fourth contact pin. The provision of a guide slot of this type makes it possible for the supporting element to be guided deep into the plug body of the first plug, thus enabling precise mechanical guidance of the contact pins supported thereby. The guidance is particularly precise when a guide slot of this type and a slide slot of the plug housing are arranged in planes parallel to one another. This arrangement allows the guidance of the supporting element by two slots and therefore a mechanically very secure and precise guidance.

This guidance not only has mechanical advantages, but also serves to increase the electrical safety. Since the path of displacement of the corresponding supporting element is predetermined in a precise manner, it is possible to largely avoid any jamming or damage of the electrical lines necessary in this region.

It is possible to equip a travel adapter according to the invention with a sliding selector, wherein a slide position is provided for each plug and the sliding selector is connected to a control knob provided on the outer side of the housing and a displacement of the selected plug between the standby position and the usage position is allowed only in dependence of the slide position of the sliding selector. Such a sliding selector can comprise a blocking element, by means of which other plugs are locked in the standby position.

Alternatively, it is possible to dispense with a sliding selector. In the case of a travel plug adapter of this type, there is thus no sliding selector provided in addition to the actuation sliders. This is then particularly practical when, due to a mechanism other than that of the sliding selector, the simultaneous actuation of more than one actuation slider is avoided.

Within the scope of the present invention a precise guidance of the third and fourth contact pins in the plug body of the first plug is possible. This allows very secure and reliable mechanics. Thus, it is often possible to dispense with a sliding selector and to avoid transferring two plugs into the usage position using different mechanical means.

Within the scope of the present invention it is also expedient to provide a locking element, which arrests at least the first plug or the second plug in the usage position. This locking element is expediently connected to a release button provided externally on the housing. It can be resiliently pre-stressed against the release direction. The provision of a locking element is particularly useful so that plugs are reliably held in the usage position. Because, for example, the first and the second and also the third and the fourth contact pin can have different lengths, a minimal displacement from the usage position might not be immediately noticed, but can be reliably prevented with the locking element.

The described invention allows a particularly compact design of the travel plug adapter. The particularly simple connection within the first plug body is also possible. Although the arrangement of contact pins of another standard within the plug body of the first plug is at the least not intuitive, this breakthrough in thinking on the basis of plug standards makes it possible to create very short connection paths. This additionally significantly increases the electrical safety in the case of current-conducting lines.

It is useful when the housing of the travel plug adapter has slide slots or similar recesses. The actuation elements or sliders may run in these slide slots. A slide slot may also be provided additionally for the sliding selector. Slide slots permit the movement of a slider while it is also being guided. Thus they represent an advantageous and cost-effective mechanical solution. Since, as a rule, a plurality of actuation elements or sliders are provided on the travel plug adapter, it is particularly advantageous when they may be guided in the slide slots in a simple manner.

The optional locking element may be designed as a separate component from the sliding selector. Alternatively, the locking element may also be a component connected to the sliding selector. The embodiment as a separate component potentially has production advantages. The sliding selector is a component that does not have to convey or withstand large forces. However, due to its nature, the locking element must reliably exert enough force to hold a plug of each standard in the usage position.

For similar reasons it is useful when the locking element is also a separate component from the actuation sliders. In this case the locking element shall be construed to be a separate component when it has at least one component that is not also a part of the sliding selector or an actuation slider. In general, it is useful when all components of the locking element are embodied separately from the components of the sliding selector and also from the components of the actuation sliders.

It is useful when the locking element is connected to a release button that is provided on the exterior of the housing and is to be actuated in a release direction. Such a release button permits intuitive and safe release of the locking element when a plug is to be moved out of the usage position back into the standby position. This design appears safer and more reliable than those in which certain movements of the actuation slider or even the sliding selector or even the plug itself lead to releasing the plug. So that the release button cannot be actuated inadvertently, it may also be provided with warning indicators or be designed in a warning colour, for instance in red. The release button may be part of the housing, for instance if due to suitable design a part of the housing can be depressed. As a rule it is useful to provide a recess in the housing and to provide the release button in this recess as a part that is independent of the housing. The release button may usefully be arranged opposing the sliding selector and/or the actuation sliders.

It is useful when the locking element, if any, is resiliently pre-stressed against the release direction. Resiliently pre-stressing the locking element permits plugs to be reliably snapped into a lock as soon as the plugs are in the usage position. It is also advantageous mechanically when the springs act precisely against the release direction.

A useful embodiment of an (optional) locking element is an embodiment in which the locking element has at least one locking leg and this locking leg has a slide surface and a locking projection. An element that is connected to a moved plug may slide on the slide surface. This element may then snap in at the locking projection so that the plug connected to the element is locked.

A travel plug adapter is useful in which at least one plug has a sliding projection or is mechanically securely connected to such and the sliding projection runs on the slide surface and can assume a locking position on the locking projection, if any.

Also useful is a travel plug adapter in which the locking means has a plurality of locking legs, for instance two, three, or four locking legs. The number of locking legs may be exactly the same as the number of plugs. It may also be useful and sufficient when the number of locking legs is less than the number of plugs.

Especially in the latter case it is useful when at least two plugs are each connected to a sliding projection and both sliding projections run on the same locking leg of the locking element. Since the two sliding projections run on the same locking leg, this means that the two sliding projections run on the same slide surface and on the same locking projection on which the two sliding projections can assume a locking position. Because two plugs in the travel plug adapter are not supposed to be moved into the usage position at the same time, the sliding projections alternatively assume this locking position on the locking projection. However, if two sliding projections, for instance two sliding projections of adjacent plugs, share a suitably dimensioned locking leg, the number of locking legs may be reduced and the travel plug adapter may thus be constructed even more compactly.

Additional features, but also advantages, of the invention, result from the drawings in the following and the associated description. Features of the invention are described in the figures and associated descriptions in combination. These feature may, however, also be included in other combinations of an inventive subject matter. Each disclosed feature should thus also be considered to be disclosed in technically reasonable combinations with other features. Some of the figures are have been slightly simplified and are diagrammatic.

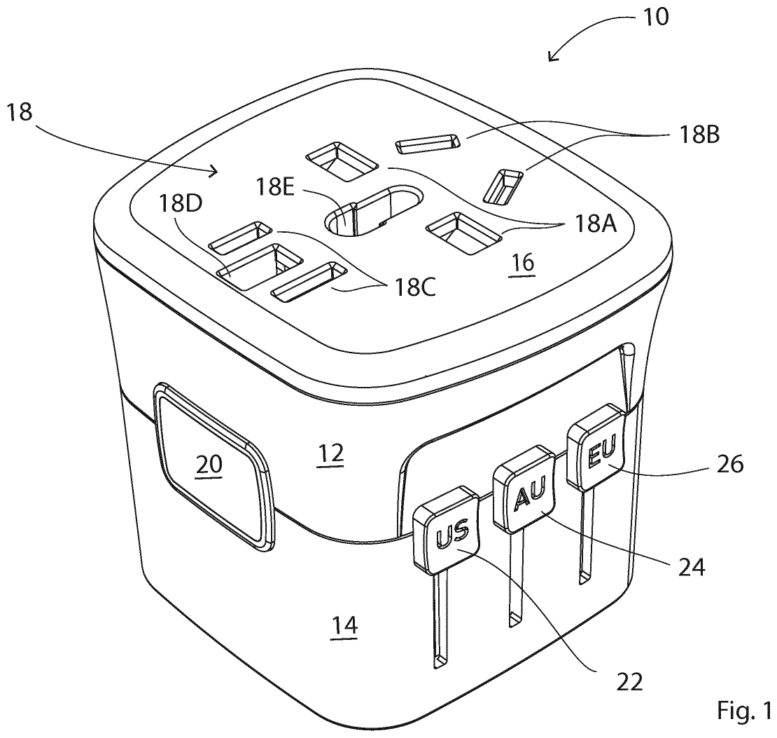

FIG. 1 is a perspective representation of an exemplary embodiment of an inventive travel plug adapter,

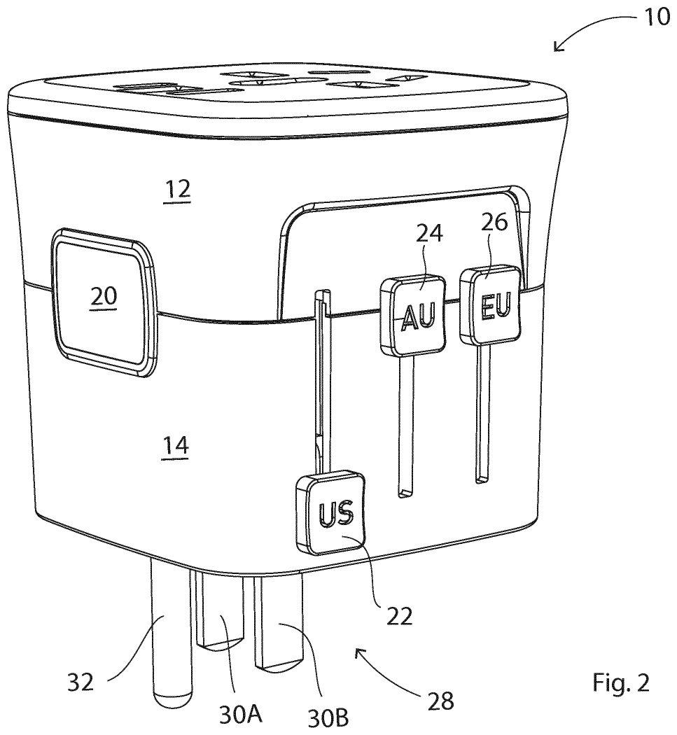

FIG. 2 provides a representation, from a similar perspective, of the exemplary embodiment of the travel plug adapter in which the US plug has been moved to the usage position,

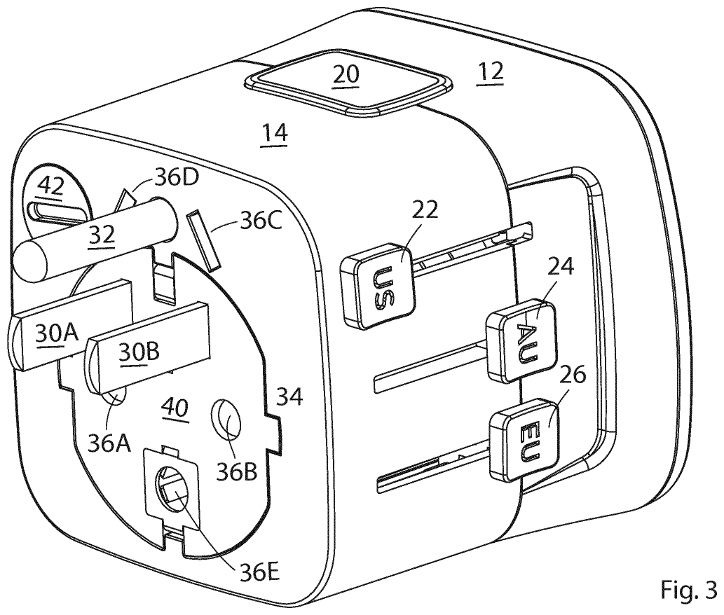

FIG. 3 is a perspective representation of the travel plug adapter according to FIG. 2 in which the underside is visible,

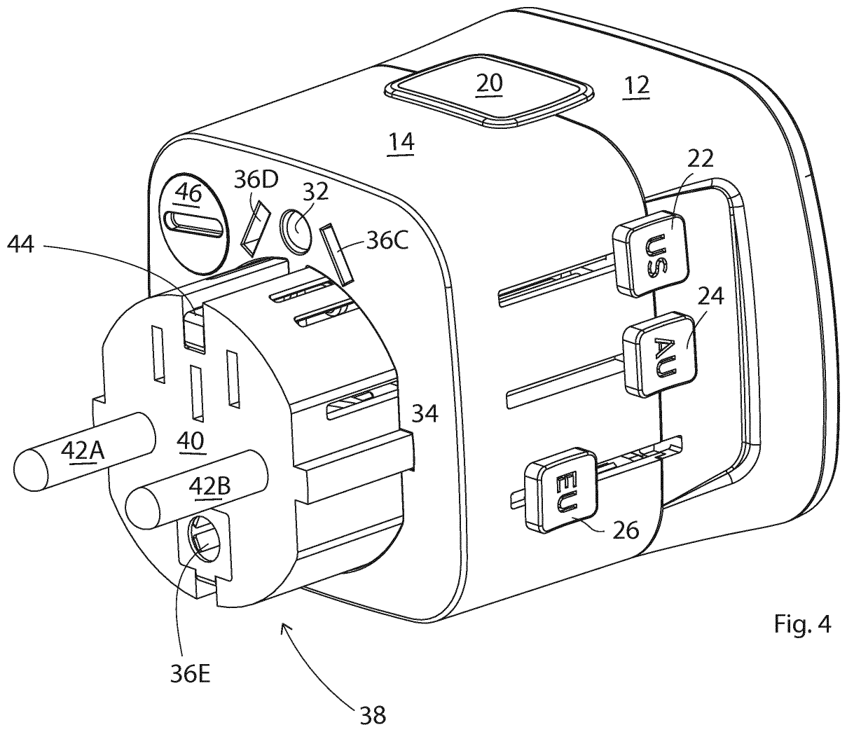

FIG. 4 is a corresponding perspective representation of the travel adapter from FIG. 3 in which the Schuko plug has been transferred into the use position,

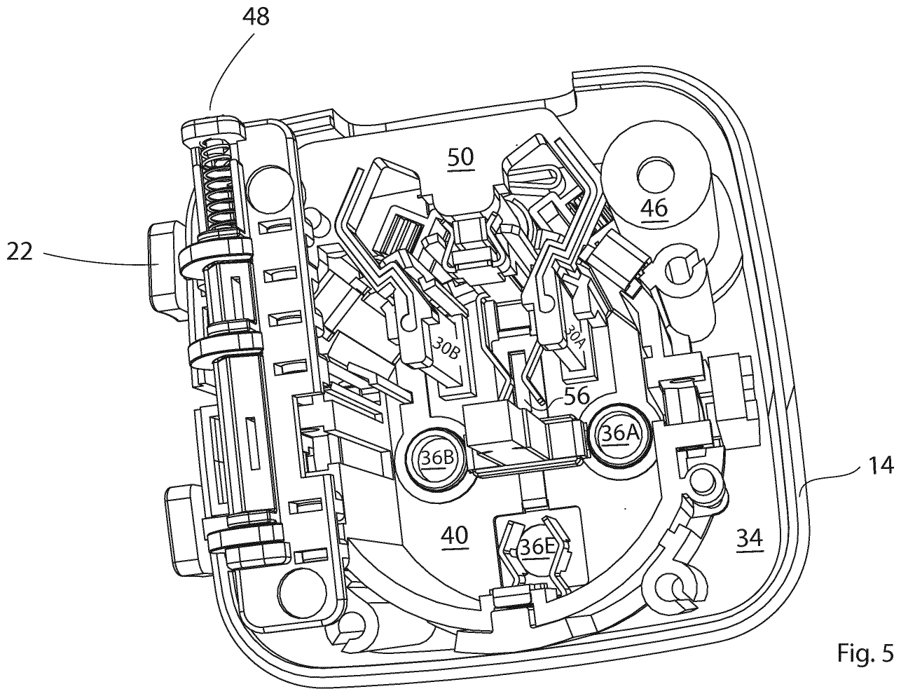

FIG. 5 is a perspective elevation of selected cooperating components of the travel adapter,

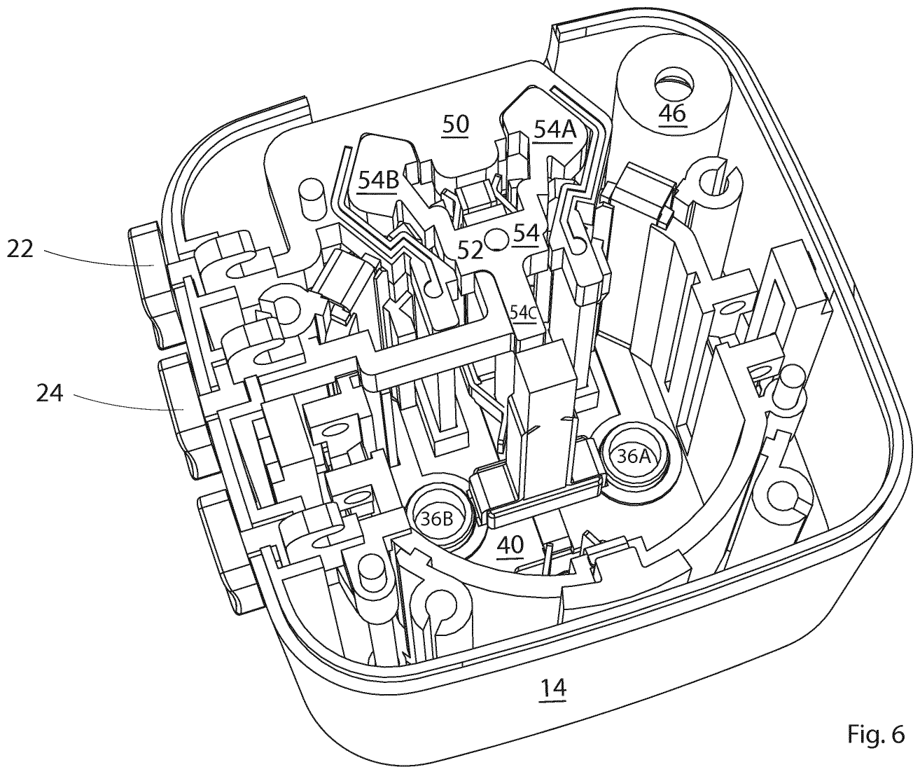

FIG. 6 is a similar perspective elevation of selected cooperating components, wherein a further supporting frame for an AU plug is visible,

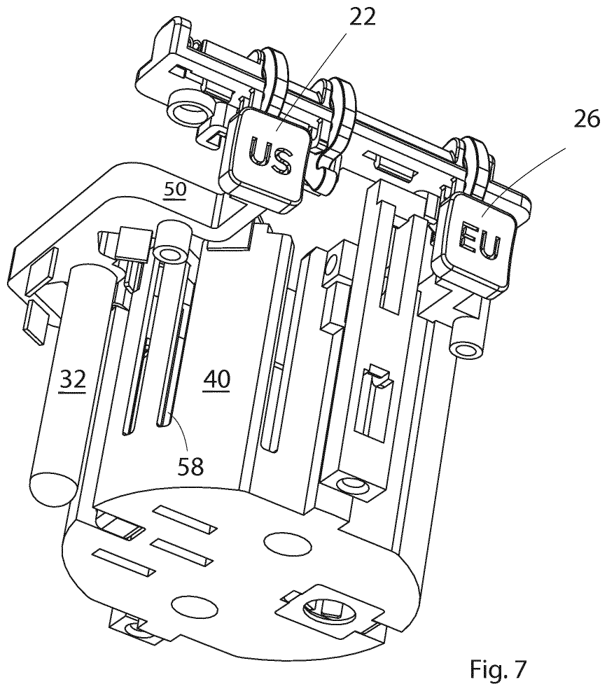

FIG. 7 is a perspective elevation of selected cooperating components, in particular the housing of the Schuko plug,

FIG. 1 is a perspective representation of an inventive travel plug adapter 10 that is ready for use, but is not yet in the usage position. Instead, all of the plugs are in the standby position, i.e., in the housing.

In the following, first the most essential elements of the travel plug adapter 10 shall be described. The travel plug adapter has a housing that consists of an upper housing part 12 and a lower housing part 14. The upper housing part 12 and the lower housing part 14 together form the main plug housing. Disposed on the top side of the travel adapter plug, and thus in the area of the upper housing part 12, is the plug receptacle 16. The latter has a plurality of female connectors 18. More specifically, these are the female connector pair 18A for receiving current-conducting UK contact pins, the female connector pair 18B for receiving current-conducting AU contact pins, the female connector pair 18C for receiving current-conducting US contact pins, the connector 18D for receiving a UK grounding pin, and the connector 18E for receiving a US grounding pin or AU grounding pin.

The release button 20 is also provided on the housing side. Said release button serves to lock and release actuation elements. On the housing front side there are provided the first actuation slider 22, by means of which the US contacts can be slid out, the second actuation slider 24, by means of which the AU contacts can be slid out, and the third actuation slider 26, by means of which a Schuko plug can be slid out.

FIG. 2 is a perspective representation of the exemplary embodiment of the travel plug adapter according to the invention in which the actuation slider 22 has been transferred into its lower position. The contact pins for the US plug 28 protrude from the housing accordingly. The US plug 28 comprises two current-conducting contact pins (the pins 30A and 30B) and also a grounding pin 32. In the illustrated position the travel adapter can be inserted into an outlet according to the US standard. This standard does not require a plug body to be used. The housing underside of the travel plug adapter 10 then lies flush on the flat surface of the plug according to the US standard.

In FIG. 3 the same travel adapter is illustrated from a different perspective. Here, it can be clearly seen that the underside 34 is planar. However, a multiplicity of openings 36 and elements are provided on this underside. The openings 36A and 36B are provided for current-conducting Schuko contact pins. The openings 36C and 36D are provided for current-conducting AU contact pins. The opening 38 is provided for an additional grounding pin. The opening 38 is provided together with the openings 36A and 36B in the plug body 40 of the Schuko plug. In addition to this plug body, a securing insert 46 is also provided.

FIG. 4 provides a representation, from the same perspective, of the travel plug adapter according to the invention in which the Schuko plug has been moved to the usage position. The third actuation slider 26 has been brought into its lower position, accordingly. The plug body 40 of the Schuko plug protrudes beyond the underside 34 of the housing. The current-conducting contact pins 42A and 42B of the Schuko plug in turn protrude from the Schuko plug. In accordance with the standard, grounding contacts 44 are disposed on the sides of the plug body.

FIG. 5 is a perspective elevation of selected cooperating components of the travel adapter 10. With the upper housing part removed, it is possible to see into the inside of the plug, i.e. substantially those components that are received by the lower housing part 14 can be seen. It should also be noted that not all components necessary for the function of the plug are illustrated. For the sake of clarity, a selection has been made.

The plug body 40 of the Schuko plug can be seen. In this, there are provided the openings 36A and 36B for the current-conducting contact pins of the Schuko plug. The opening 36E, which is provided for a grounding contact pin, can also be seen. In this representation a further opening can also be seen—the opening 56 for the grounding pin of the AU plug.

The current-conducting contact pins 30A and 30B for the US plug are also illustrated. These are in their standby position, i.e. are retracted into the housing. The first actuation slider 22 is in the upper position, accordingly. The actuation slider 22 can be held in this position by the locking mechanism 48.

The actuation slider 22 moves the supporting bar 50. The contact pins 30A and 30B are fixed to this supporting bar 50. The supporting bar 50 travels downward accordingly as the first actuation slider 22 is displaced in the direction of the base of the housing. In so doing, the contact pins 30A and 30B are guided in the plug body 40 of the Schuko plug. The Schuko plug thus provides a guide for contact pins of another standard.

FIG. 6 is a similar perspective representation of a similar selection of cooperating components. Here, as key difference from FIG. 5, the supporting bar 52 for the AU plug can also be seen. The supporting bar 52 is connected to the actuation slider 24. The supporting bar 52 has three bar ends, the bar ends 54A, 54B and 54C, which merge in the region 54. The bar ends 54A and 54B support the current-conducting contacts of the AU plug. They guide these contacts mechanically from the (shown) standby position into the usage position. The bar end 54C guides the AU grounding pin. The grounding pin is thus transferred from the (shown) standby position into the usage position through the opening 56 visible in FIG. 5.

An arrangement in which the current-conducting pins are guided outside the plug housing 40 of the Schuko plug is thus selected for the AU plug, in contrast to the grounding pin within the plug housing 40 of the Schuko plug. By contrast, the current-conducting contact pins for the US plug are guided within the plug body 40 of the Schuko plug. Both solutions allow an advantageous and space-saving arrangement. Different solutions can be selected for different plugs. Different solutions can be selected for different plugs.

FIG. 7 is a perspective view of other selected cooperating components of the exemplary embodiment of the travel plug adapter. Here, the actuation slider 22 for the US plug and the actuation slider 24 for the EU plug (embodied as a Schuko plug) can be seen. The supporting arm 50 is connected to the actuation slider 22. The supporting arm 50 guides the grounding pin 32, which is moved outside the plug body 40 of the Schuko plug. The supporting arm 50 by contrast guides the current-conducting contacts of the US plug within the plug body 40 of the Schuko plug. A guide slot 58 is provided accordingly in the plug body 40. This guide slot 58 allows the supporting bar 50 to engage deep in the plug body 40, thus enabling a secure mechanical guidance of the US contact pins.

In the manner described generally, and described more specifically in the drawings, a travel adapter may be produced that is very comfortable to operate, but in which almost no operating errors are to be expected. Interestingly, the travel adapter is nevertheless inexpensive to produce and may also be produced inexpensively and reliably even if greater fault tolerances must be permitted during mass production.

### REFERENCE LIST

10 Travel adapter/travel plug adapter
12 Upper housing part
14 Lower housing part
16 Plug receptacle
18 Female connector
18A UK female connector pair
18B AUS female connector pair
18C US female connector pair
18D Female connector for UK grounding pin
18E US grounding pin
20 Release button
22 First actuation slider
24 Second actuation slider
26 Third actuation slider
28 US plug
30 Current-conducting contact pins (US plug)
32 Grounding pin (US plug)
34 Plug body (Schuko plug)
36 Openings
36A Opening of current-conducting contacts (Schuko)
36B Opening of current-conducting contacts (Schuko)
36C Opening of current-conducting contacts (US)
36D Opening of current-conducting contacts (US)
36E Opening of further grounding contact
38 Schuko plug
40 Plug body of Schuko plug
42 Current-conducting contacts of Schuko plug
44 Grounding contact of Schuko plug
46 Fuse compartment
48 Locking mechanism
50 Supporting bar US
52 Opening of grounding pin
54 Supporting bar AU
56 Supporting bar ends AU
58 Guide slot

1. Travel plug adapter (10) which has a housing, a plug receptacle (16) and at least a first plug (38) of a first standard and a second plug (28) of a second standard, wherein each plug is assigned an actuation slider (22, 24, 26), which is guided outwardly through a slide slot in the housing and is designed to displace the plug between a standby position, in which the plug is disposed substantially inside the housing, and a usage position, in which the plug is usably disposed outside the housing, wherein the first plug comprises a plug body (40) and a first contact pin (42A) and a second contact pin (42B), wherein, in the usage position, both the plug body (40) and the first contact pin (42A) and the second contact pin (42B) are usably disposed outside the housing, and, in the standby position, both the plug body and the first contact pin (42A) and the second contact pin (42B) are disposed in the housing, wherein the second plug (28) comprises a third contact pin (30A) and a fourth contact pin (30B), and the third contact pin (30A) and the fourth contact pin (30B) are also guided in the plug body (40) of the first plug (38).

2. Travel plug adapter (10) according to claim 1, in which the second plug (28) is transferred into the usage position by merely transferring the third contact pin (30A) and the fourth contact pin (30B) into the usage position.

3. Travel plug adapter (10) according to claim 1, in which the first plug (38) also has a grounding contact which is disposed outside the plug body (40).

4. Travel plug adapter (10) according to claim 1, in which the second plug (28) has a grounding contact (44) arranged at a distance from the plug body (40) of the first plug (38).

5. Travel plug adapter (10) according to claim 1, in which a third plug is also provided, wherein at least one contact of the third plug is guided in the plug body (40) of the first plug (38).

6. Travel plug adapter (10) according to claim 5, in which two current-conducting contacts of the third plug are guided in the plug body (40) of the first plug (38).

7. Travel plug adapter (10) according to claim 6, in which the at least one contact of the third plug is a grounding contact.

8. Travel plug adapter (10) according to claim 1, in which two current-conducting contacts of the third plug are guided outside the plug body (40) of the first plug (38).

9. Travel plug adapter (10) according to claim 1, in which the second plug (28) and the third plug have the same polarisation.

10. Travel plug adapter (10) according to claim 1, in which the plug body (40) of the first plug (38) has a guide slot (58) for a supporting element of the second plug (28).

11. Travel plug adapter (10) according to claim 1, in which a sliding selector is provided with a slide position for each plug and the sliding selector is connected to a control knob provided on the outer side of the housing and has a blocking element, and a displacement of the selected plug between the standby position and the usage position is allowed only in dependence of the slide position of the sliding selector, whilst other plugs are arrested in the standby position by the blocking element.

12. The travel plug adapter (10) according to claim 1, in which no sliding selector is provided in addition to the actuation sliders (22, 24, 26).

13. Travel plug adapter (10) according to claim 1, in which a locking element is provided that arrests at least the first plug (38) or the second plug (28) in the usage position.

14. Travel plug adapter (10) according to claim 13, in which the locking element is connected to a release button (20) provided outside on the housing.

15. Travel plug adapter (10) according to claim 2, in which the first plug (38) also has a grounding contact which is disposed outside the plug body (40).

16. Travel plug adapter (10) according to claim 2, in which the second plug (28) has a grounding contact (44) arranged at a distance from the plug body (40) of the first plug (38).

17. Travel plug adapter (10) according to claim 2, in which a third plug is also provided, wherein at least one contact of the third plug is guided in the plug body (40) of the first plug (38).

18. Travel plug adapter (10) according to claim 2, in which two current-conducting contacts of the third plug are guided outside the plug body (40) of the first plug (38).

19. Travel plug adapter (10) according to claim 2, in which the second plug (28) and the third plug have the same polarisation.

20. Travel plug adapter (10) according to claim 2, in which the plug body (40) of the first plug (38) has a guide slot (58) for a supporting element of the second plug (28).
